(19) United States
(12) Patent Application Publication
(10) Pub. No.: US 2022/0330073 A1
(43) Pub. Date: Oct. 13, 2022

(54) HANDLING CONFIGURATIONS FOR REPORTING CHANNEL STATE INFORMATION

(71) Applicant: ZTE CORPORATION, Shenzhen (CN)

(72) Inventors: Yong LI, Shenzhen (CN); Hao WU, Shenzhen (CN); Zhaohua LU, Shenzhen (CN); Chuangxin JIANG, Shenzhen (CN)

(21) Appl. No.: 17/853,375

(22) Filed: Jun. 29, 2022

Related U.S. Application Data
(63) Continuation of application No. PCT/CN2020/097884, filed on Jun. 24, 2020.

(51) Int. Cl. H04W 24/10; H04W 72/12; H04L 5/00; H04B 7/06

(52) U.S. Cl. CPC H04W 24/10; H04W 72/1289; H04L 5/0053; H04B 7/063; H04B 7/0626

(57) ABSTRACT

Presented are systems, methods, apparatuses, or computer-readable media for handling configuration of channel state information (CSI) reports. A wireless communication node may determine a first configuration of at least one CSI report. The first configuration may include an identification of each of the at least one CSI report. The wireless communication node may transmit the first configuration to a wireless communication device. The wireless communication node may receive the at least one CSI report from the wireless communication device.

### CROSS-REFERENCE TO RELATED APPLICATION

This application claims the benefit of priority under 35 U.S.C. § 120 as a continuation of PCT Patent Application No. PCT/CN2020/097884, filed on Jun. 24, 2020, the disclosure of which is incorporated herein by reference in its entirety.

### TECHNICAL FIELD

The disclosure relates generally to wireless communications, including but not limited to systems and methods for handling configurations for reporting channel state information (CSI).

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A wireless communication node may determine a first configuration of at least one channel state information (CSI) report. The first configuration may include an identification of each of the at least one CSI report. The wireless communication node may transmit the first configuration to a wireless communication device. The wireless communication node may receive the at least one CSI report from the wireless communication device.

In some embodiments, the first configuration may specify to the wireless communication device to provide a precoding matrix indicator (PMI) that comprises a data transmission PMI for a first link, that is configured as an interference PMI to a second link.

In some embodiments, the wireless communication node may determine the first configuration. The first configuration may be of a first CSI report and a first link of the wireless communication device (e.g., for which to generate the first CSI report). In some embodiments, the wireless communication node may determine a second configuration of a second CSI report and a second link of the wireless communication device (e.g., for which to generate the second CSI report). The first configuration may assign an identification (e.g., identifier or ID) to the first report, include (e.g., but may not assign) an identification of the second report, specify to the wireless communication device to provide a data transmission precoding matrix indicator (PMI) for the first link, and indicate that the first link interferes with the second link (e.g., so that the first CSI report can be generated by taking this interference into account).

In some embodiments, the wireless communication node may determine the first configuration. The first configuration may be of a first CSI report and a first link of the wireless communication device. In some embodiments, the wireless communication node may determine a second configuration of a second CSI report and a second link of the wireless communication device. The first configuration may assign an identification to the first report, include an identification of the second report, and indicate that the first link is interfered with by the second link (e.g., so that the first CSI report can be generated by taking this interference into account). The second configuration may assign the identification of the second report to the second report, and specify to the wireless communication device to provide a data transmission precoding matrix indicator (PMI) for the second link.

In some embodiments, the wireless communication node may determine the first configuration. The first configuration may be of a first CSI report, and a first link and a second link of the wireless communication device. The first configuration may assign an identification to the first report, specify to the wireless communication device to provide a data transmission precoding matrix indicator (PMI) for the first link, and indicate that the first link and the second link interfere with each other (e.g., so that CSI reports can be generated by the wireless communication device by taking this interference into account).

In some embodiments, the wireless communication node may determine the first configuration of the at least one CSI report. The first configuration may include information about interference between links of the wireless communication device. In some embodiments, the wireless communication node may determine the first configuration. The first configuration may be of a first CSI report and a plurality of links of the wireless communication device, and indicate that the plurality of links interfere with each other.

In some embodiments, the wireless communication node may determine the first configuration. The first configuration may include an identification of each of a plurality of CSI reports corresponding to a plurality of links of the wireless communication device, and indicate that the plurality of links interfere with each other.

In some embodiments, the wireless communication node may determine the first configuration. The first configuration may be of a first CSI report and a plurality of links of the wireless communication device, and indicate a subset of links from the plurality of links that interfere with a first link of the plurality of links.

In some embodiments, the wireless communication node may send a single downlink control information (DCI) transmission (e.g., instead of multiple DCI transmissions) to the wireless communication device to initiate transmission of a plurality of CSI reports. In some embodiments, the wireless communication node may determine the first configuration. The first configuration may include an identification of each of a plurality of CSI reports. In some embodiments, the wireless communication node may send a single downlink control information (DCI) transmission to the wireless communication device to initiate transmission of the plurality of CSI reports.

In some embodiments, the wireless communication node may determine the first configuration. The first configuration may include an identification of each of a plurality of CSI reports. In some embodiments, the wireless communication node may send a single downlink control information (DCI) transmission to the wireless communication device to initiate transmission of a subset of the plurality of CSI reports.

In some embodiments, the wireless communication node may send a single downlink control information (DCI) transmission to the wireless communication device to initiate transmission of a plurality of CSI reports corresponding to links of the wireless communication device that interfere with each other.

At least one aspect is directed to a system, method, apparatus, or a computer-readable medium. A wireless communication device may receive, from a wireless communication node, a first configuration of at least one channel state information (CSI) report. The first configuration may include an identification of each of the at least one CSI report. The wireless communication device may transmit, to the wireless communication node, the at least one CSI report from the wireless communication device.

In some embodiments, the first configuration may specify to the wireless communication device to provide a precoding matrix indicator (PMI) that comprises a data transmission PMI for a first link, that is configured as an interference PMI to a second link.

In some embodiments, the wireless communication device may receive the first configuration. The first configuration may be of a first CSI report and a first link of the wireless communication device. In some embodiments, the wireless communication device may receive a second configuration of a second CSI report and a second link of the wireless communication device. The first configuration may assign an identification to the first report, include an identification of the second report, specifies to the wireless communication device to provide a data transmission precoding matrix indicator (PMI) for the first link, and indicate that the first link interferes with the second link.

In some embodiments, the wireless communication device may receive the first configuration, wherein the first configuration is of a first CSI report and a first link of the wireless communication device. In some embodiments, the wireless communication device may receive a second configuration of a second CSI report and a second link of the wireless communication device. In some embodiments, the first configuration may assign an identification to the first report, include an identification of the second report, and indicate that the first link is interfered with by the second link. In some embodiments, the second configuration may assign the identification of the second report to the second report, and specify to the wireless communication device to provide a data transmission precoding matrix indicator (PMI) for the second link.

In some embodiments, the wireless communication device may receive the first configuration. The first configuration may be of a first CSI report, and a first link and a second link of the wireless communication device. The first configuration may assign an identification to the first report, specify to the wireless communication device to provide a data transmission precoding matrix indicator (PMI) for the first link, and indicate that the first link and the second link interfere with each other.

In some embodiments, the wireless communication device may receive the first configuration of the at least one CSI report. The first configuration may include information about interference between links of the wireless communication device. In some embodiments, the wireless communication device may receive the first configuration. The first configuration may be of a first CSI report and a plurality of links of the wireless communication device, and indicate that the plurality of links interfere with each other.

In some embodiments, the wireless communication device may receive the first configuration. The first configuration may include an identification of each of a plurality of CSI reports corresponding to a plurality of links of the wireless communication device, and indicate that the plurality of links interfere with each other. In some embodiments, the wireless communication device may receive the first configuration. The first configuration may be of a first CSI report and a plurality of links of the wireless communication device, and indicate a subset of links from the plurality of links that interfere with a first link of the plurality of links.

In some embodiments, the wireless communication device may receive a single downlink control information (DCI) transmission from the wireless communication node to initiate transmission of a plurality of CSI reports. In some embodiments, the wireless communication device may receive the first configuration. The first configuration may include an identification of each of a plurality of CSI reports. In some embodiments, the wireless communication device may receive a single downlink control information (DCI) transmission from the wireless communication node to initiate transmission of the plurality of CSI reports.

In some embodiments, the wireless communication device may receive the first configuration. The first configuration may include an identification of each of a plurality of CSI reports. In some embodiments, the wireless communication device may receive a single downlink control information (DCI) transmission from the wireless communication node to initiate transmission of a subset of the plurality of CSI reports. In some embodiments, the wireless communication device may receive a single downlink control information (DCI) transmission from the wireless communication node to initiate transmission of a plurality of CSI reports corresponding to links of the wireless communication device that interfere with each other.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates a block diagram of an example system for handling configurations for reporting channel state information; and

FIG. 4 illustrates a functional band diagram of an example method of handling configurations for reporting channel state information.

### DETAILED DESCRIPTION

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

The following acronyms are used throughout the present disclosure:

| Acronym | Full Name |
|---|---|
| 3GPP | 3rd Generation Partnership Project |
| 5G | 5th Generation Mobile Networks |
| 5G-AN | 5G Access Network |
| 5G gNB | Next Generation NodeB |
| CN | Core Network |
| CSI | Channel State Information |
| CSI-RS | CSI Reference Signal |
| DCI | Downlink Control Information |
| DL | Down Link or Downlink |
| MIMO | Multiple-Input and Multiple-Output |
| NW | Network |
| OFDM | Orthogonal Frequency-Division Multiplexing |
| OFDMA | Orthogonal Frequency-Division Multiple Access |
| PDCCH | Physical Downlink Control Channel |
| PDCP | Packet Data Convergence Protocol |
| PDSCH | Physical Downlink Shared Channel |
| PDU | Protocol Data Unit |
| PHY | Physical Layer |
| PMI | Precoding Matrix Indicator |
| PUCCH | Physical uplink control channel |
| QoS | Quality of Service |
| RAN | Random Access Network |
| RB | Resource Block |
| RE | Resource Element |
| RLC | Radio Link Control |
| RS | Reference Signal |
| RRC | Radio Resource Control |
| SSB | Synchronization Signal Block |
| SRI | SRS Resource Indicator |
| SRS | Sounding Reference Signal |
| TC | Transmission Configuration |
| TCI | Transmission Configuration Indicator |
| UE | User Equipment |
| UL | Up Link or Uplink |

### 1. Mobile Communication Technology and Environment

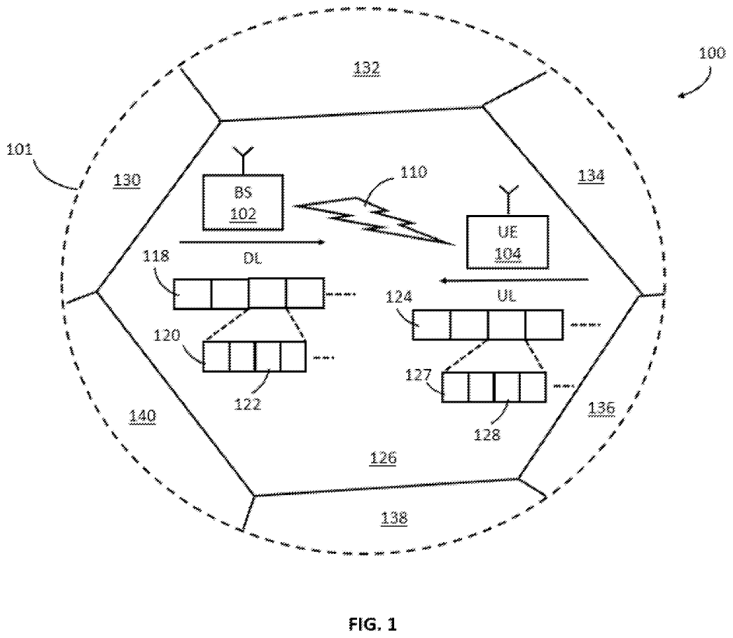

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

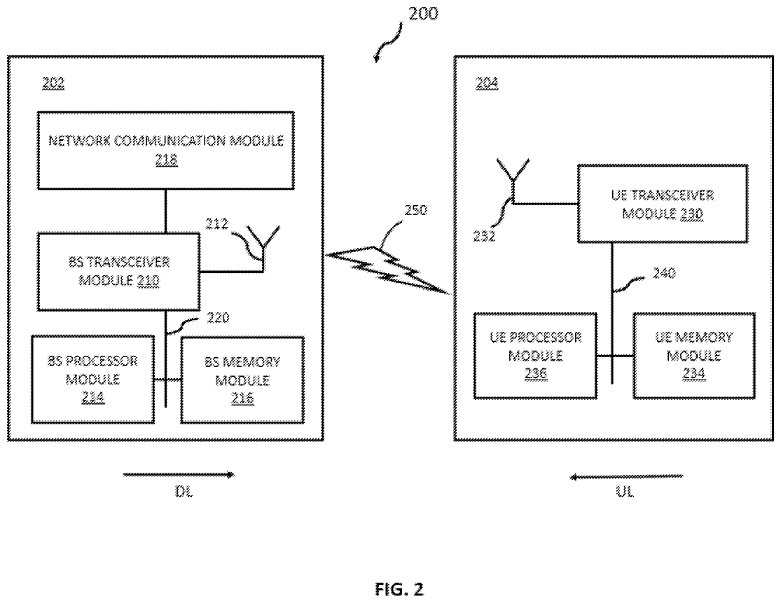

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

### 2. Systems and Methods for Handling Configurations for Reporting Channel State Information

During the transmission process of the wireless communication network, formulating a transmission strategy according to Channel State Information (CSI) can improve the efficiency as well as reduce interference. Having or receiving more CSI and more accurate CSI can also benefit the efficiency of the data transmissions. On the other hand, acquiring more CSIs results in the occupation of more resources, resulting in decreased efficiency. To maintain or improve efficiency, the overhead for acquiring CSIs may be reduced. During the transmission process of the wireless communication network, a wireless communication node (e.g., the BS 102) may expect one or more CSI reports satisfying its requirement from a wireless communication device (e.g., the UE 104).

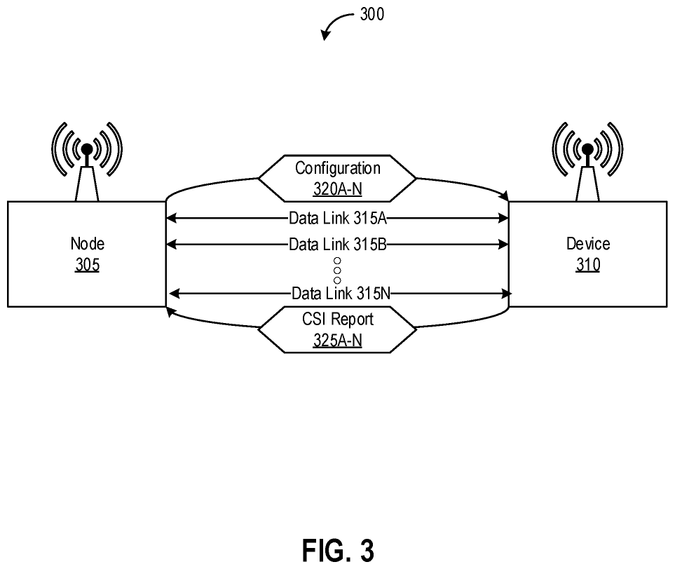

Referring now to FIG. 3, depicted is a block diagram of a system 300 for handling configurations for reporting channel state information. In brief overview, the system 300 may include at least one wireless communication node 305 (sometimes referred to as node 305) and at least one wireless communication device 310 with one or more data links 315A—N (hereinafter generally referred to as data links 315) established between the wireless communication node 305 and the wireless communication device 310. At least one of the data links 315 (e.g., a first data link 315A) may interfere with another of the data links (e.g., a second data link 315B). One or more of the components of system 300 may be, include, or correspond to one or more components of the system 100. For example, the wireless communication node 305 may correspond to the BS 102 and the wireless communication device 310 may correspond to the UE 104, and the data links may be established over the network 100.

In further detail, the node 305 may direct the requirements with the configuration 320A-N (hereinafter generally referred to as configuration 320) of the CSI report 325 A-N (hereinafter generally referred to as CSI report 325), and may assign an identification to the report 325. The configuration 320 may indicate a CQI (channel quality indicator) or a data transmission PMI (precoding matrix indicator). The configuration 320 may also describe a data transmission link or more than one data transmission link to a wireless communication device 310, or an interference relation between the links. The configuration 320 may indicate a interfering PMI from a link or to a link. The wireless communication device 310 may generate and/or transmit the CSI reports (e.g., for the link(s)) according the configuration 320. Then, the data transmission(s) via one or more of the link(s) may be benefited from the CSIs. The PMI here may be used for MIMO transmission with multiple antennas.

In some embodiments, the configuration 320 may indicate or provide for a PMI that is used for a data transmission PMI for one data link and an interference PMI for another data link. In some scenarios, there may be more than one data link (e.g., data links 315A and 315B) available or established to a wireless communication device 310 at the same time. For example, the wireless communication device 310 may have multiple data links for one or more corresponding base stations or one or more transmission points. A particular data link with one wireless communication node 305 (e.g., base station or transmission point) may interfere some other data link. The wireless communication node 305 (e.g., the base station or transmission point) may expect the wireless communication device 310 to feedback the data transmission PMIs and/or the interference PMIs, for example, in CSI reports sent to the wireless communication node 305. The feedback by the wireless communication device 310 may include sending the data PMIs and interference PMIs via CSI reports to the node 305.

To reduce the overhead from the feedback, the wireless communication node 305 may provide one PMI that operate as (or can be used as) a data transmission PMI for one data link, and also operate as (or can be used as) an interference PMI with/for another link. For example, there may be two data links with a wireless communication device 310, a first data link 315A and a second data link 315B. The first data link 315A with one transmission point may interfere with the second data link 315B with another transmission point. Separate feedback on each of the data transmission PMI and interference PMI may together occupy more resources relative to feedback on a single PMI. The feedback of multiple PMIs (e.g., the data transmission PMI and interference PMI) via a single PMI may thus reduce overhead. In a scenario with more than one data links with a device 310, the relationship between the requested PMI (or returned PMI) and the links may be identified. Otherwise, the PMI may operate incorrectly. For example, the interference PMI to the first data link 315A may inadvertently be (incorrectly) used as a data transmission PMI for the first data link 315A as opposed to the second data link 315B.

In some embodiments, a configuration 320 of a CSI report 325 related to data link may be determined. These may correspond to a first configuration 320A, a first report 325A, and a first data link 315A for instance. Another configuration 320 may be determined for another CSI report 325 related to another data link. These may correspond to a second configuration 320B, a second report 325B, and a second data link 315B for example. The first configuration 320A may assign an identification (e.g., identifier or ID) to the first report 325A, may include (but may not assign) the identification of the second report 325B, may identify a data PMI for the first data link 315A, and may indicate that the first data link 315A interferes with the second data link 315B (e.g., to be accounted for by the wireless communication device, when producing a CSI report).

The wireless communication node 305 may direct the wireless communication device 310 to feedback a data transmission PMI for the first data link 315A in the first report 325A, and may indicate that the data transmission PMI for the first data link 315A is also an interfering (or interference) PMI for the second data link 315B, for example with the first data link 315A interfering the second data link 315B. The relationship between the returned PMI and the link may be identified. Since one PMI is fed back for (or that includes) both the data transmission PMI and the interference PMI, the overall overhead for feedback of the single PMI is reduced. Another benefit from the indication that the data transmission PMI for one link is the interference PMI for another link may be that the wireless communication device 310 can feedback a minimally or low-level interfering PMI to the second data link 315B, thereby allowing data transmission via the first data link to be configured/adjusted/modified (according to the interfering PMI) to reduce the interference to the second data link 315B.

The wireless communication node 305 may determine that the first configuration 320A for the first report 325A is related to the first data link. The first configuration 320A may assign an identification to the first report 325A, may identify the data transmission PMI for the first data link 315A, may indicate that the data transmission PMI is the interference PMI for the second data link 315B, and may also include (but may not assign) the identification of the second report 325B, and may indicate that the first data link 315A interferes with the second data link 315B. Also, the wireless communication node 305 may determine a second configuration 320B for the second report 325B related to the second data link 315B. The second configuration 320B may assign an identification to the second report 325B.

In some embodiments, a configuration 320 of a CSI report 325 related to a data link may be determined. For example, we may refer to these as a first configuration 320A, a first report 325A, and a first data link 315A. Another configuration 320 of another CSI report 325 related to another data link may be determined. We may refer to these as a second configuration 320B, a second report 325B, and a second data link 315B for instance. The first configuration 320A may assign an identification of the first report 325A, may include (but may not assign) an identification of the second report 325B, and may indicate that the second data link 315B interferes with the first data link 315A. The second configuration 320B may assign the identification of the second report 325B, and may specify the data transmission PMI for the second data link 315B.

Under this scheme, the wireless communication node 305 may specify that the wireless communication device 310 to: feedback a data transmission PMI for the second data link 315B in the second data link 315B and to indicate that an interference PMI to the first link is also (included in or represented by) the data transmission PMI for the second data link 315B with the second data link 315B interfering with the first data link 315A in the first configuration 320A. The node 305 may also specify that the wireless communication device 310 is to feedback the CSI for the first data link 315A in the first report 325A based on the interference PMI from/for the second data link 315B. Thus, the relationship between the returned PMI and the links may be clear. Using one PMI to feedback both the data transmission PMI and the interference PMI may reduce the overall overhead. Another benefit of indicating that the interference PMI to the first data link 315A is the fed back data transmission PMI for the second data link 315B may be that the wireless communication device 310 can feedback a more accurate CSI For the first data link 315A in the first report 325A based on the interference PMI from the second data link 315B.

The wireless communication node 305 may, for example, determine the first configuration 320A for the first report 325A related to the first data link 315A. The first configuration 320A may assign an identification to the first report 325A, may indicate that the interference PMI to the first data link 315A is the data transmission PMI for the second data link 315B. The identification of the second report 325B may indicate that the second data link 315B interferes with the first data link 315A. Also, the wireless communication node 305 may determine a second configuration 320B for a second report 325B to a second data link 315B, with the second configuration 320B assigning an identification to the second report 325B and specifying the data PMI for the second data link 315B.

In some embodiments, the configuration 320 of a CSI report 325 related to two data links (e.g., the first data link 315A and the second data link 315B) may be determined. These may be referred to as a first configuration 320A, a first report 325A, the first data link 315A, and the second data link 315B. The first configuration 320A may assign the identification for the first report 325A, specify a data transmission PMI for the first data link 310A and another data transmission PMI for the second link 310B, and may indicate that the first data link 310A and the second data link 310B may interfere with each other.

In the scheme, the wireless communication node 305 may indicate to the wireless communication device 310 to provide a data transmission PMI for the first data link 315A and another data transmission PMI for the second data link 315B in a single CSI report 325. The wireless communication node 305 may indicate that the interference PMI for the first data link 315A is a data transmission PMI to the second data link 315B, and that the interference PMI for the second data link 315B is a data transmission PMI for the first data link 315A, with the first data link 315A and the second data link 315B interfering with each other, in the first configuration 320A. The wireless communication node 305 may indicate to the wireless communication device 310 to provide the CSI for the first data link 315A based on the interference PMI from the second data link 315B, and the CSI for the second data link 315B based on the interference PMI for the first data link 315A in a single report 325.

Thus, the relationship between the fed back PMIs and the data links 315A may be clearly specified. Using one PMI to feedback both the data transmission PMI and the interference PMI may reduce the overall overhead. Another benefit of the indication of the interference PMI to the first data link 315A being the fed back PMI for the second data link 315B, may be that the wireless communication device 310 can provide a more accurate CSI for the first data link 315A in the first report 325A based on the interference PMI from the second data link 315B. Another benefit of the indication that the fed back data transmission PMI for the first data link 315A is the interference PMI for the second data link 315B may be that the wireless communication device 310 can feed back a minimally or low-level interfering/interference PMI for the second data link 315B (e.g., the PMI indicates/describes minimal or low level(s) of interference to the second data link 315B). Therefore, the interference PMI may be used to configure data transmission(s) (e.g., in the first link and/or other links) to reduce the interference to the second data link 315B. Feedback of both the data transmission PMI for the first data link 315A and the PMI for the second data link 315B may be present in one report 325, thereby reducing overall overhead by providing the single report 325.

For example, the wireless communication node 305 may determine the first configuration 320A for the first CSI report 325A related to the first data link 315A and the second data link 315B. The first configuration 320A may assign an identification to the first CSI report 325A, indicate that the interference PMI to the first data link 315A may be the data transmission PMI for the second data link 315B, and the interference PMI to the second data link 315B may be the data transmission PMI for the first data link 315A, and may indicate that the first data link 315A and the second data link 315B interfere with each other.

In some embodiments, the configuration 320 may be determined/established to indicate that the interference relationships among the data links 315 (instead of using the PMI relationships) related to the CSI reports 325. Under this scenario, there may be more than one available/established data link 315 to the wireless communication device 310 at the same time. One data link 315 may interfere with another data link 315. In the configuration 320, the wireless communication node 305 may indicate the interference relationship(s) between the data links 315. The wireless communication device 310 may receive the interference relationship(s) between the data link 315 from the configuration 320.

Since the wireless communication node 305 may identify the data transmission environment, the interference relationship indicated by the configuration 320 may be suited to (or applicable to) the data transmission environment. Therefore, the accuracy of the fed back CSI considering the interference relationships between the data links 315 as indicated in the configuration 320 determined by the wireless communication node 305 may be improved. Based on the improved CSI, the data transmission efficiency may also be enhanced.

In some embodiments, a configuration 320 may be determined to include the configuration 320 of the CSI report 325 related to M data links 315 (with M>1). A first configuration 320A, a first report 325A, the data links 315 may be flagged for description. The first configuration 320A may assign the identification of the first report 325A and indicate that all the data links 315 interfere with one another.

Under this scheme, the wireless communication node 305 may indicate/describe in the configuration 320 an interference relationship that all the M data links interfere with one another. The accuracy of the fed back CSI, considering the interference relationships between the data links 315 as indicated in the configuration 320 by the wireless communication node 305, may be improved. The indication that all the M data links 315 interfere with one another may reduce overall overhead, relative to indicating that certain individual data links 315 interfere with each other. For example, the indication that all the data links 315 interfere with one another can be set by a bit or a flag. The indication that all the M data links 315 interfere with another in one configuration 320 of the CSI report 325 may simplify the configuration 320, thereby resulting in the reduction in the complexity of the system 300. For instance, the wireless communication node 305 may determine or generate the first configuration 320A for the first report 325A related to the M data links 315. The first configuration 320A may assign the identification to the first report 325A, and may indicate that all the M data links 315 interfere with one another.

In some embodiments, a configuration 320 may be determined or be generated to include an identification of each CSI report 325 of a set of CSI reports 325, and to indicate that all data links 315 related to the set of CSI reports 325 interfere with one another. Each CSI report 325 may include information about interference to the corresponding data link 315 and interference from the corresponding data link 315 to other data links 315.

Under this scheme, the wireless communication node 305 may indicate, in the configuration 320, the interfering relationships identifying all the data links 315 (related to the set of CSI reports 325) that interfere with one another. The accuracy of the fed back CSI considering the interference relationships between the data links 315 (indicated in the configuration 320) may thus be improved. The indication that all the data links 315 interfere with one another may reduce overall overhead, in comparison with providing individual indications of the interference of the data links 315 one by one. For example, the indication that all the M data links 315 interfere one another can be set with a bit or a flag (e.g., in the configuration 320). The indication of the interference relationships for the data links 315 related to different reports 305 may improve the flexibility of the system 300. For instance, the wireless communication node 305 may determine/generate the configuration 320 to include a set of identification of the CSI reports 325, and may indicate that all the data links 315 (related to the CSI reports 325) in the set interfere each other.

In some embodiments, a configuration 320 of a CSI report 325 related to M data links 315 (with M>1) may be determined. These may be referred to as a first configuration 320A, a first CSI report 325A, and M data links 315. The first configuration 320A may assign the identification of the first report 325A, and may indicate the interfering the data links 315 among the M data links 315 to one data link 315. In some embodiments, the indication may indicate which data links 315 (e.g., a subset) interferes with one of the data links 315.

Under this scheme, the wireless communication node 305 may indicate, in the configuration 320, the interference relationships with the data links 315 interfering with one another among the M data links 315 to one of the data links 315. The accuracy of the fed back CSI, considering the interference relationships among the data links 315 as indicated in the configuration 320 by the wireless communication node 305, may be improved. The indication of the data links 315 that are interfering with another among the M data links 315 to one of the data links 315 may enhance the accuracy of the CSI of the data link 315. For instance, the wireless communication node 305 may determine the first configuration 320A for a first report 325A related to the M data links 315. The first configuration 320A may assign an identification to the first report 325A, and may indicate/identify the specific interfering data links 315 among the M data links 315 that interfere with the data link 315 (e.g., the first data link 315A).

In some embodiments, a wireless communication node 305 may trigger K CSI reports 325 through a downlink control information (DCI) format signaling (sometimes referred to as DCI signaling or DCI transmission). Under some scenarios, there may be more than one interfered states (e.g., data links 325), such that the CSI reporting may comprise providing one report 325 from each of the interfered states to improve data transmission efficiency. The individual triggering of multiple reports 325 one-by-one may consume much overhead in the DCI format signaling. In contrast, one DCI format signaling triggering K CSI reports 325 may result in the reduction of overhead associated with the signaling.

In some embodiments, a configuration 320 may be determined to include a set of identification of the K CSI reports 325. A DCI format signaling may be used to trigger all of the K CSI reports 325. For example, the wireless communication node 305 may assign the identification of the set in the configuration 320, and may trigger the set with the identification of the set for all the CSI reports 325 in the set via a DCI format signaling.

In some embodiments, a configuration 320 may be determined to include a set of identification of the K CSI reports 325. In triggering the set, a subset of CSI reports 325 may be selected from the set to be triggered via a DCI format signaling. For example, the wireless communication node 305 may trigger a set of identification of K CSI reports 325 and can do this by setting bits in a field in a DCI format signaling. In the DCI format signaling, bits may be set to indicate corresponding CSI reports 325 from the set to be triggered. In another example, the wireless communication node 305 may trigger the set, and can set bits in a field in DCI format signaling. In the DCI format signaling, bits may be set to indicate a corresponding group of CSI reports 325 in the set to be triggered.

In some embodiments, a set of CSI reports 325 may be triggered in a DCI format signaling. The data links 315 may be related to the CSI reports 325 in that the set may interfere with each other. Under this scheme, the CSI reports 325 may be triggered in a (single) DCI format signaling, and may decrease delays between correlative CSI reports among the data links 315 interfering with one another. This may save time delay relative to individually triggering CSI reports via the DCI format signaling one-by-one.

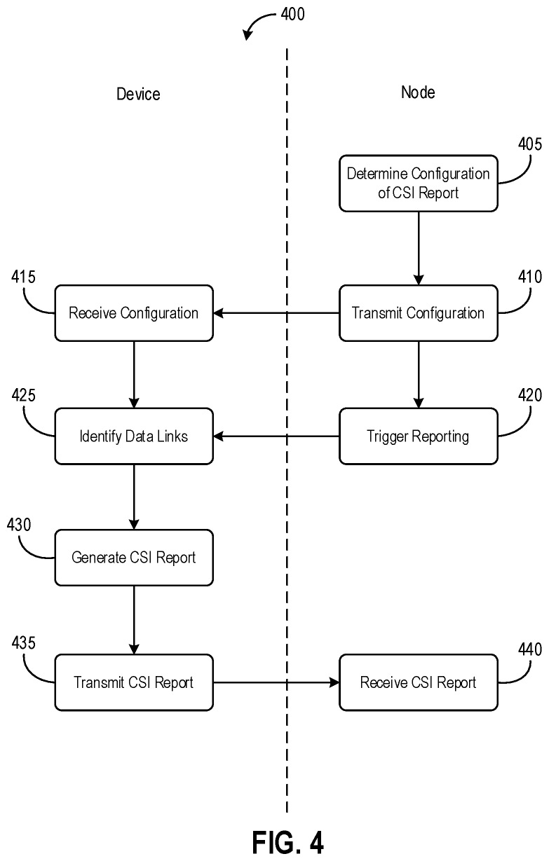

Referring now to FIG. 4, depicted is a functional band diagram of a method 400 of handling configurations for reporting channel state information. The method 400 may be implemented or performed by any of the components described above, such as the base station 102, the user equipment 104, the node wireless communication node 305, and the wireless communication device 310, among others. In brief overview, a wireless communication node may determine a configuration of a CSI report (405). The wireless communication node may transmit the configuration (410). A wireless communication device may receive the configuration (415). The wireless communication node may trigger reporting (420). The wireless communication device may identify data links (425). The wireless communication device may generate a CSI report (430). The wireless communication device may transmit the CSI report (435). The wireless communication node may receive the CSI report (440).

In further detail, a wireless communication node (e.g., the wireless communication node 305) may generate, create, or otherwise determine at least one configuration (e.g., the configuration 320) of a CSI report (e.g., the CSI report 325) (405). The configuration may define or specify the generation and content of CSI reports related to one or more links (e.g., the data links 315) to be provided by a wireless communication device. The links may have been established between the wireless communication node (or another transmission point) and a wireless communication device (e.g., the wireless communication device 310). The configuration may identify or assign identifications to reports to be provided. The configuration may specify one or more indicators for the CSI report describing one or more data links and interference relations among the links. The indicator may include, for example, a channel quality indicator (CQI), a data transmission precoding matrix indicator (PMI), a channel state information reference signal (CSI-RS) indicator, a layer indicator (LI), a rank indicator (RI), or a synchronization signal (SS) and physical broadcast channel (PBCH) (SS/PBCH) block indicator, among others. The PMI may be used to describe MIMO transmission with multiple antennae between the wireless communication node and the wireless communication device.

In some embodiments, the wireless communication node may determine the configuration for one or more CSI reports for one or more links. The configuration may define, specify, or otherwise include one or more identifications of the CSI report to be provided back to the wireless communication node. In some embodiments, the configuration may specify the wireless communication device to provide the indicator (e.g., PMI). The PMI may include or identify a data transmission for a first link (e.g., the first data link 315A) and may be used an interference PMI to a second link (e.g., the second data link 315B). In some embodiments, the wireless communication node may determine a first configuration (e.g., the first configuration 320A) to include an identification of each CSI report (e.g., the CSI report 320). The configuration may indicate, include, or otherwise identify one or more links interfering with one another. In some embodiments, the wireless communication node may determine a first configuration (e.g., the first configuration 320A) of at least one CSI report (e.g., the CSI report 325). The first configuration may include interference among links of the wireless communication device.

In some embodiments, the wireless communication node may determine multiple configurations for multiple CSI reports and different data links. In some embodiments, the wireless communication node may determine a first configuration (e.g., the first configuration 320A) to be of a first CSI report (e.g., the first CSI report 325A) and of a first link (e.g., the first data link 315A). In some embodiments, the wireless communication node may determine a second configuration (e.g., the second configuration 320B) to be of a second CSI report (e.g., the second CSI report 325B) and of a second link (e.g., the second data link 315B). Each configuration may include identifications of reports or assignments of identifications of reports. In addition, the configuration may specify the wireless communication device to provide an indicator (e.g., a data transmission PMI) for one or more of the links and indicate interference relationships among the links. In some embodiments, the first configuration may assign an identification of the identification to the first report, specify to the wireless communication device to provide an indicator (e.g., the data transmission PMI) for the first link, and may indicate that the first link interferes with the second link. In some embodiments, the first configuration may assign an identification to the first report, include an identification of the second report, and indicate that the first link is interfered by the second link. In addition, the second configuration may assign the identification of the second report to the second report itself, and specify to the wireless communication device to provide an indicator (PMI) for the second link.

In some embodiments, the wireless communication node may determine a single configuration for multiple CSI reports and different data links. In some embodiments, the wireless communication node may determine a first configuration (e.g., the first configuration 320A). The first configuration may be of a first report (e.g., the first CSI report 325A), and of a first link (e.g., the first link 310A) and a second link (e.g., the second link 310B) of the wireless communication device. The first configuration may assign an identification to the first report, specify to the wireless communication to provide an indicator (e.g., a data transmission PMI) For the first link, and may indicate that the first link and the second link interfere with each other.

In some embodiments, the wireless communication node may determine a single configuration for multiple CSI reports and sets of data links. In some embodiments, the wireless communication device may determine a first configuration (e.g., the first configuration 320A) for a set of links. In some embodiments, the first configuration may be of a first CSI report (e.g., the first CSI report 325A) and of the set of links (e.g., the data links 310) of the wireless communication device. In some embodiments, the first configuration may include an identification of each CSI report (e.g., the CSI report 325) corresponding to one of the links (e.g., the data links 310) of the wireless communication device, and may indicate that the set of links interfere with one another. The interference relationship identified in the first configuration may indicate that the set of links all interfere with one another. In some embodiments, the wireless communication node may determine a first configuration (e.g., the first configuration 320A) for the set of links (e.g., the data links 310). The first configuration may be of a first CSI report (e.g., the first CSI report 325A) and of the set of links, and may indicate that a subset of the links interfere with a first link (e.g., the first data link 310A). The interference relationship identified in the first configuration may indicate one or more other links from the set of links interfere with each other.

The wireless communication node may send, provide, or otherwise transmit the configuration (410). Upon determination of the configuration, the wireless communication node may transmit the configuration to the wireless communication device. In some embodiments, the wireless communication node may transmit the configuration via at least one of the links identified by the configuration. The wireless communication device may retrieve, identify, or otherwise receive the configuration from the wireless communication node (415). In some embodiments, the wireless communication device may receive the first configuration of at least one CSI report. The first configuration may include identification of one or more CSI reports. The first link may be of the first CSI report and the first link of the wireless communication device. In some embodiments, the wireless communication device may receive the second configuration of the second CSI report and of the second link of the wireless communication device.

The wireless communication node may initiate, cause, or otherwise trigger reporting (420). In some embodiments, the wireless communication node may transmit, provide, or otherwise send a single downlink control information (DCI) transmission to the wireless communication device to initiate transmission of one or more CSI reports (e.g., the CSI reports 325). The DCI transmission of the CSI reports may be in accordance with the configuration. In some embodiments, the DCI transmission may be based on an identification of the links in the configuration. In some embodiments, the wireless communication node may send the single DCI transmission to initiate a transmission of a set of the CSI reports (e.g., the CSI reports 325). Each CSI report in the transmission may correspond to a link (e.g., the data link 310) identified or assigned in the configuration. In some embodiments, the wireless communication node may send the single DCI transmission to initiate transmission of a subset of the CSI reports (e.g., the CSI reports 325). The subset of CSI reports in the transmission may correspond to the subset of links identified or assigned in the configuration. In some embodiments, the wireless communication node may send the single DCI transmission to initiate transmission of a set of CSI reports corresponding to links that interfere with one another. The set of CSI reports in the transmission may correspond to links identified as interfering with one another in the configuration. The wireless communication device may in turn receive the single DCI transmission from the wireless communication node to initiate transmission of one or more CSI reports to the wireless communication node.

The wireless communication device may determine or otherwise identify data links (425). Upon receipt of the configuration, the wireless communication device may parse the configuration to identify the one or more links identified by the configuration. In some embodiments, the identification may be in response to receipt of the single DCI transmission from the wireless communication node. In some embodiments, the wireless communication device may identify the links for which a CSI report (e.g., the CSI report 325) is to be provided. In some embodiments, the wireless communication device may identify a set of links identified by the interference relationship specified by the configuration.

The wireless communication device may determine, create, or generate a CSI report (e.g., the CSI report 325) (430). In accordance to the configuration, the wireless communication device may generate the CSI report for one or more of the links. The links for which CSI reports are to be provided may be identified by the configuration. In generating the CSI report for each link, the wireless communication device may measure, identify, or otherwise determine one or more indicators. The indicator may include, for example, a channel quality indicator (CQI), a data transmission precoding matrix indicator (PMI), a channel state information reference signal (CSI-RS) indicator, a layer indicator (LI), a rank indicator (RI), or a synchronization signal (SS) and physical broadcast channel (PBCH) (SS/PBCH) block indicator, among others. In some embodiments, the wireless communication device may use the indicator (e.g., a data transmission PMI) for a first link (e.g., the first data link 310A) as the interference indicator (e.g., an interference PMI) to a second link (e.g., the second data link 310B). With the identification of the indicators, the wireless communication device may generate the CSI report for each link to include the corresponding indicator.

The wireless communication device may send, provide, or otherwise transmit the CSI report (435). Upon generation, the wireless communication device may transmit the one or more CSI reports to the wireless communication node. Each CSI report provided may have been identified by the configuration. The wireless communication node may retrieve, identify, or otherwise receive the CSI report from the wireless communication device (440).

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

What is claimed is:

1. A method, comprising:
determining, by a wireless communication node, a first configuration of at least one channel state information (CSI) report, the first configuration including an identification of each of the at least one CSI report;
transmitting, by the wireless communication node, the first configuration to a wireless communication device; and
receiving, by the wireless communication node, the at least one CSI report from the wireless communication device.

2. A wireless communication node comprising:
at least one processor configured to:
determine a first configuration of at least one channel state information (CSI) report, the first configuration including an identification of each of the at least one CSI report;
transmit, via a transceiver, the first configuration to a wireless communication device; and
receive, via the transceiver, the at least one CSI report from the wireless communication device.

3. A method, comprising:
receiving, by a wireless communication device, from a wireless communication node, a first configuration of at least one channel state information (CSI) report, the first configuration including an identification of each of the at least one CSI report; and
transmitting, by the wireless communication device, to the wireless communication node, the at least one CSI report from the wireless communication device.

4. The method of claim 3, wherein the first configuration specifies to the wireless communication device to provide a precoding matrix indicator (PMI) that comprises a data transmission PMI for a first link, that is configured as an interference PMI to a second link.

5. The method of claim 3, comprising:
receiving, by the wireless communication device, the first configuration, wherein the first configuration is of a first CSI report and a first link of the wireless communication device; and
receiving, by the wireless communication device, a second configuration of a second CSI report and a second link of the wireless communication device,
wherein the first configuration assigns an identification to the first report, includes an identification of the second report, specifies to the wireless communication device to provide a data transmission precoding matrix indicator (PMI) for the first link, and indicates that the first link interferes with the second link.

6. The method of claim 3, comprising:
receiving, by the wireless communication device, the first configuration, wherein the first configuration is of a first CSI report and a first link of the wireless communication device; and
receiving, by the wireless communication device, a second configuration of a second CSI report and a second link of the wireless communication device,
wherein the first configuration assigns an identification to the first report, includes an identification of the second report, and indicates that the first link is interfered with by the second link, and
wherein the second configuration assigns the identification of the second report to the second report, and specifies to the wireless communication device to provide a data transmission precoding matrix indicator (PMI) for the second link.

7. The method of claim 3, comprising:
receiving, by the wireless communication device, the first configuration, wherein the first configuration is of a first CSI report, and a first link and a second link of the wireless communication device; and
wherein the first configuration assigns an identification to the first report, specifies to the wireless communication device to provide a data transmission precoding matrix indicator (PMI) for the first link, and indicates that the first link and the second link interfere with each other.

8. The method of claim 3, comprising:
receiving, by the wireless communication device, the first configuration of the at least one CSI report, wherein the first configuration includes information about interference between links of the wireless communication device.

9. The method of claim 3, comprising:
receiving, by the wireless communication device, the first configuration, wherein the first configuration is of a first CSI report and a plurality of links of the wireless communication device, and indicates that the plurality of links interfere with each other.

10. The method of claim 3, comprising:
receiving, by the wireless communication device, the first configuration, wherein the first configuration includes an identification of each of a plurality of CSI reports corresponding to a plurality of links of the wireless communication device, and indicates that the plurality of links interfere with each other.

11. The method of claim 3, comprising:
receiving, by the wireless communication device, the first configuration, wherein the first configuration is of a first CSI report and a plurality of links of the wireless communication device, and indicates a subset of links from the plurality of links that interfere with a first link of the plurality of links.

12. The method of claim 3, comprising:
receiving, by the wireless communication device, a single downlink control information (DCI) transmission from the wireless communication node to initiate transmission of a plurality of CSI reports.

13. The method of claim 3, comprising:
receiving, by the wireless communication device, the first configuration, wherein the first configuration includes an identification of each of a plurality of CSI reports; and
receiving, by the wireless communication device, a single downlink control information (DCI) transmission from the wireless communication node to initiate transmission of the plurality of CSI reports.

14. The method of claim 3, comprising:
receiving, by the wireless communication device, the first configuration, wherein the first configuration includes an identification of each of a plurality of CSI reports; and
receiving, by the wireless communication device, a single downlink control information (DCI) transmission from the wireless communication node to initiate transmission of a subset of the plurality of CSI reports.

15. The method of claim 3, comprising:
receiving, by the wireless communication device, a single downlink control information (DCI) transmission from the wireless communication node to initiate transmission of a plurality of CSI reports corresponding to links of the wireless communication device that interfere with each other.

16. A wireless communication device, comprising:
at least one processor configured to:
receive from a wireless communication node a first configuration of at least one channel state information (CSI) report, the first configuration including an identification of each of the at least one CSI report; and
transmit to the wireless communication node, the at least one CSI report from the wireless communication device.

17. The wireless communication device of claim 16, wherein the first configuration specifies to the wireless communication device to provide a precoding matrix indicator (PMI) that comprises a data transmission PMI for a first link, that is configured as an interference PMI to a second link.

18. The wireless communication device of claim 16, wherein the at least one processor is further configured to:
receive the first configuration, wherein the first configuration is of a first CSI report and a first link of the wireless communication device; and
receive a second configuration of a second CSI report and a second link of the wireless communication device,
wherein the first configuration assigns an identification to the first report, includes an identification of the second report, specifies to the wireless communication device to provide a data transmission precoding matrix indicator (PMI) for the first link, and indicates that the first link interferes with the second link.

19. The wireless communication device of claim 16, wherein the at least one processor is further configured to:
receive the first configuration, wherein the first configuration is of a first CSI report and a first link of the wireless communication device; and
receive a second configuration of a second CSI report and a second link of the wireless communication device,
wherein the first configuration assigns an identification to the first report, includes an identification of the second report, and indicates that the first link is interfered with by the second link, and
wherein the second configuration assigns the identification of the second report to the second report, and specifies to the wireless communication device to provide a data transmission precoding matrix indicator (PMI) for the second link.

20. The wireless communication device of claim 16, wherein the at least one processor is further configured to:
receive the first configuration, wherein the first configuration is of a first CSI report, and a first link and a second link of the wireless communication device; and
wherein the first configuration assigns an identification to the first report, specifies to the wireless communication device to provide a data transmission precoding matrix indicator (PMI) for the first link, and indicates that the first link and the second link interfere with each other.
